(19) United States
(12) Patent Application Publication
(10) Pub. No.: US 2025/0072312 A1
(43) Pub. Date: Mar. 6, 2025

(54) SEEDFILM PRODUCTION APPARATUS AND SOWING SYSTEM COMPRISING THE SAME FOR MINIMAL WATER WASTAGE

(71) Applicant: GREEN AND SEED CORPORATION, Jeollabuk-do (KR)

(72) Inventor: SUNG-JIN CHOE, Jeollabuk-do (KR)

(21) Appl. No.: 18/563,471

(22) PCT Filed: Sep. 23, 2023
(86) PCT No.: PCT/KR2023/014581

§ 371 Date: Nov. 22, 2023

(30) Foreign Application Priority Data
Jun. 20, 2023 (KR) 10-2023-0079054

(51) Int. Cl. A01C 1/04; A01C 1/02

(52) U.S. Cl. CPC A01C 1/042; A01C 1/02; A01C 1/044; A01C 2001/048

(57) ABSTRACT

A seedfilm supply apparatus includes a cutting and adhesion unit to form germination gaps for seed attachment in a biodegradable film supplied from a mulch film supply unit; a seed supply unit to feed seeds into the germination gaps formed through the cutting and adhesion unit; and a mulch film laying unit to lay the biodegradable film having the seeds attached thereto on a farmland and cover the biodegradable film with soil turned over by a soil tiller unit, wherein the cutting and adhesion unit includes a cutting actuator, a pivot plate pivotably coupled through the cutting actuator, a cutting blade unit coupled to the pivot plate, an adhesive supply unit coupled to the cutting blade unit to supply an adhesive, and an adhesion roller to transport the adhesive supplied from the adhesive supply unit to the germination gaps formed in the biodegradable film.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2023/014581, filed Sep. 23, 2023, which claims priority to the benefit of Korean Patent Application No. 10-2023-0079054 filed in the Korean Intellectual Property Office on Jun. 20, 2023, the entire contents of which are incorporated herein by reference.

### BACKGROUND

### 1. Technical Field

The present disclosure relates to a seedfilm production apparatus and sowing system that produces a seedfilm by attaching seeds to a biodegradable film while minimizing damage to the seeds using a seed attacher and then installs the seedfilm and drip irrigation tapes on the farmland using a mulch film laying unit while covering the seedfilm with soil and ensuring seed-soil contact and that minimizes water wastage by growing crops by utilizing the ability of drip irrigation to precisely supply water near the crop roots and the evaporation suppression function of biodegradable film.

### 2. Background Art

Agriculture accounts for 70% of global freshwater withdrawals including groundwater and river, and 70% of water used to produce crops worldwide is used in rice farming and wheat farming. Rice and wheat are the primary staple food for the largest portion of the world's population, and they are produced in a large amount but use a large amount of irrigation water for 1 kg production. According to the water footprint as reported by the UNESCO, 3000 liters of water is needed to produce 1 kg of rice, and 1350 liters of water is needed to produce 1 kg of wheat. As the temperature in air rises due to global warming, an increase of irrigation water is inevitable. Saudi Arabia uses more irrigation water than the global average by 50% to cultivate wheat in a hot and dry climate, and about 2000 liters of water is used to produce 1 kg of wheat. In view of some reports that as climate change becomes more severe, the risk that severe droughts may occur will increase 20-fold, there is an urgent need for irrigation water saving technology.

By this reason, many attempts have been made to save water used to produce wheat and rice. According to 2011-14 research conducted by ICAR-Central Institute of Agricultural Engineering, Bhopal in India, about 310 liters of water is used to produce 1 kg of wheat using drip irrigation, and this is a 77% decrease compared to the global average water footprint, 1350 liter/kg. Netafim has grown rice using drip irrigation, and produced more rice and used 70% less water. Drip irrigation is the most efficient among all irrigation methods and it has been reported that drip irrigation achieves yield increases up to 100% and water savings up to 40% to 80% (Burney⋅2009; Lodhi⋅2014; Kumari⋅2014).

However, despite the use of drip irrigation, it is impossible to prevent evaporation occurring in the farmland, so irrigation methods including film mulching over drip irrigation to further reduce water wastage have emerged. Q Jia (2021) shows that when comparing soil covered drip irrigation and film mulched drip irrigation, soil evaporation of soil covered drip irrigation without film mulching was greater 2.4 times than that of film mulched drip irrigation. Additionally, drip irrigation under film mulching exhibited the increased crop yield and water use efficiency by about 20% and 30%, respectively, compared to nonmulching drip irrigation (W Zhang⋅2022). The drip irrigation under film mulching is widely applied to cotton production in Xinjiang, China. However, this method has not been applied to regions or crops other than cotton in China's Xinjiang region, and the biggest reason is a lot of labor required to install drip irrigation under mulch films while mulching and severe environmental pollution caused by remaining plastic films after harvest.

### SUMMARY

The present disclosure provides a sowing system consisting of a seed attacher that attaches seeds to a biodegradable film to produce a seedfilm and a mulch film laying unit for spreading the seedfilm to farmland while installing drip irrigation tapes. It aims to minimize water wastage through a biodegradable film that prevents evaporation and drip irrigation that supplies water close to the roots.

To achieve the above-described objective, a seedfilm supply apparatus according to the present disclosure includes a cutting and adhesion unit to form germination gaps for seed attachment in a biodegradable film supplied from a mulch film supply unit; a seed supply unit to feed seeds into the germination gaps formed through the cutting and adhesion unit; and a mulch film laying unit to lay the biodegradable film having the seeds attached thereto on a farmland and cover the biodegradable film with soil turned over by a soil tiller unit, wherein the cutting and adhesion unit includes a cutting actuator, a pivot plate pivotably coupled through the cutting actuator, a cutting blade unit coupled to the pivot plate, an adhesive supply unit coupled to the cutting blade unit to supply an adhesive, and an adhesion roller to transport the adhesive supplied from the adhesive supply unit to the germination gaps formed in the biodegradable film.

The seed supply unit includes a seed supply hopper, a seed supply hose connected to a lower part of the seed supply hopper to transport the seeds to the germination gaps formed in the biodegradable film, a seed supply nozzle coupled to a lower end of the seed supply hose, a seed collection hose connected to an upper part of the seed supply hopper to collect seeds falling off from the germination gaps formed in the biodegradable film and a seed bowl disposed at a lower end of the seed collection hose to temporarily store the seeds leaking from the germination gaps formed in the biodegradable film.

The adhesive supply unit includes an adhesive supply body, an adhesive supply line disposed below the adhesive supply body to act as a movement path of the adhesive, and a roller ball attached to a lower end of the adhesive supply line.

The mulch film laying unit includes a drip irrigation hose supply unit, a fertilizer applicator to supply a predetermined amount of fertilizer to the drip irrigation hose while rotating, a plurality of rollers for placing the seedfilm on the supplied drip irrigation hose together, and a rotorvator to turn over the soil to easily lift the farmland soil to the seedfilm laid on the farmland.

The seedfilm production apparatus according to the present disclosure and the seed sowing system with minimized water wastage including the same supply seeds to the biodegradable mulch film with minimized seed damage through the cutting and adhesion unit to produce the seedfilm, and lay the seedfilm on the ground and cover up with soil to secure the seedfilm under which drip irrigation is installed to the ground using the soil tiller unit and the mulch film laying unit. Through this, it is possible to supply water close to the roots of the crop through drip irrigation and suppress water evaporation by using the biodegradable film, thereby minimizing water wastage in the crop cultivation.

### BRIEF DESCRIPTION OF THE DRAWINGS

FIG. 1 shows a biodegradable seedfilm production apparatus including a cutting and adhesion unit and a seed supply unit.

FIGS. 2 and 3 show a cutting and adhesion unit of the present disclosure.

FIG. 4 shows a seed supply unit of the present disclosure.

FIG. 5 shows a mulch film laying unit of the present disclosure.

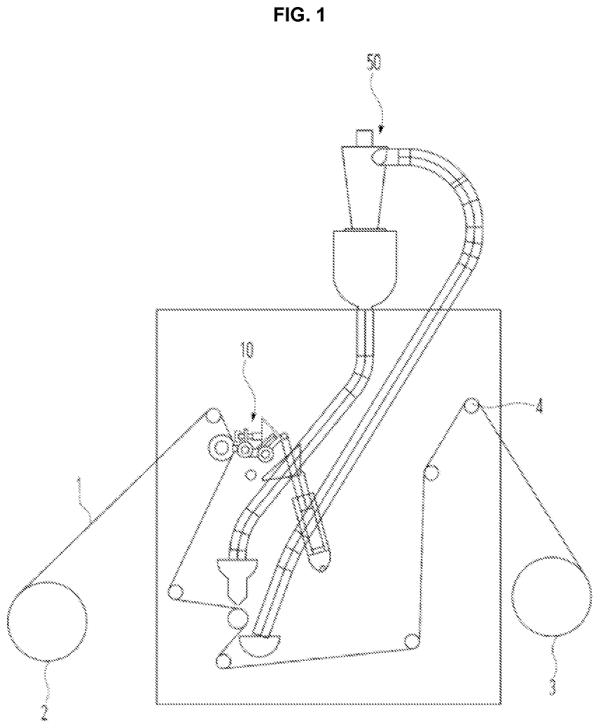

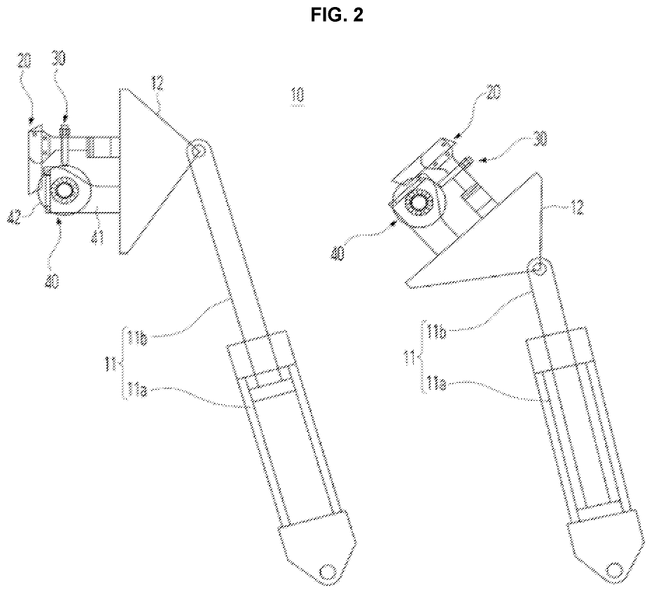

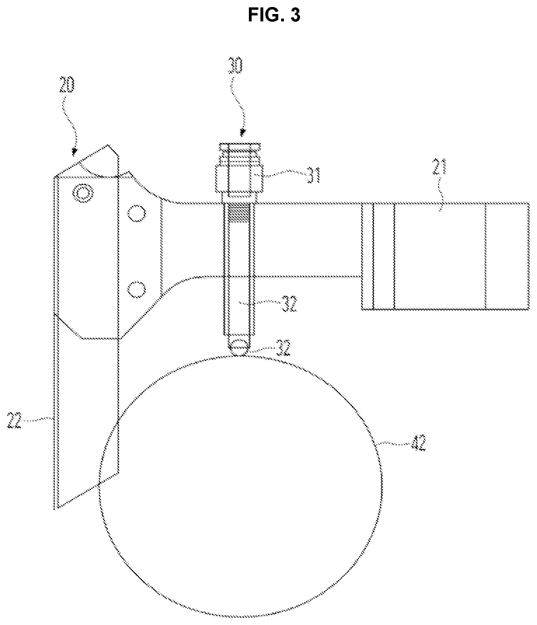

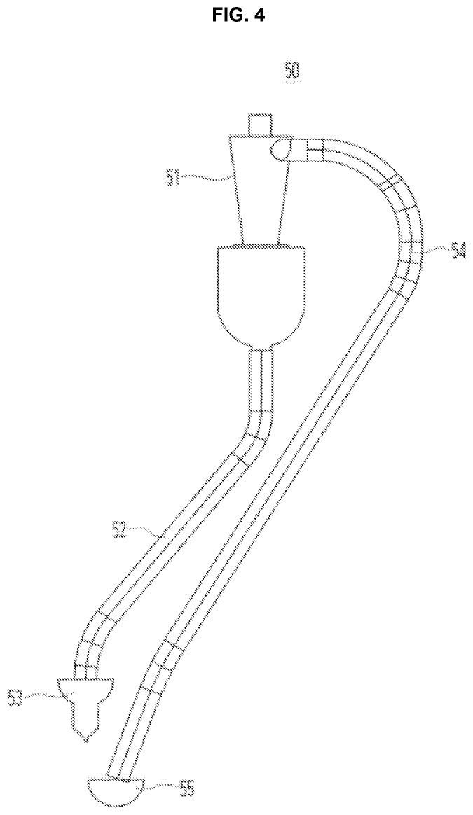

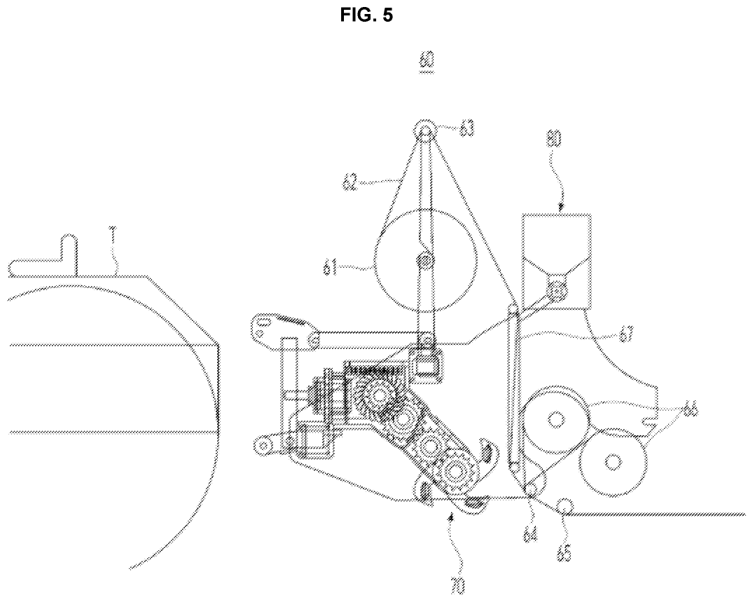

### DETAILED DESCRIPTION

Hereinafter, the embodiments of the present disclosure will be described in more detail with reference to the accompanying drawings. However, the present disclosure is not limited to the following disclosed embodiments and will be embodied in a variety of different forms, and these embodiments are provided so that this disclosure will be thorough and complete, and will fully convey the scope of the present disclosure to those skilled in the art. In the drawings, the same reference sign denotes the same element.

In adding the reference signs to the elements in each drawing, it should be noted that identical elements have reference signs that are as identical as possible although they appear in different drawings. Additionally, in describing the present disclosure, when it is determined that a certain detailed description of relevant known elements or functions may obscure the subject matter of the present disclosure, the detailed description is omitted.

Hereinafter, an apparatus for supplying a seedfilm by supplying seeds to a mulch film that is derived from plants and biodegradable with minimized seed damage using a seed attacher unit, the mulch film coated with an eco-friendly adhesive through a cutting and adhesion unit according to an embodiment of the present disclosure will be described with reference to the accompanying drawings.

The seedfilm supply apparatus according to an embodiment of the present disclosure includes a cutting and adhesion unit 10 to form germination gaps for seed attachment in a biodegradable film 1 supplied from a mulch film supply unit 2, a seed supply unit 50 to feed seeds into the germination gaps formed through the cutting and adhesion unit 10 and a mulch film laying unit 60 to lay the biodegradable film having the seeds attached thereto on the farmland and cover the biodegradable film 1 with soil turned over by a soil tiller unit or a rotorvator 70. In the present disclosure, an apparatus including the cutting and adhesion unit 10 and the seed supply unit 50 is referred to as a biodegradable seedfilm production apparatus.

After the germination gaps are formed in the biodegradable film 1 supplied from the mulch film supply unit 2 and an adhesive is supplied through the cutting and adhesion unit 10, the mulch film in which the seeds are supplied to the germination gaps through the seed supply unit 50 is wound on a mulch film collection unit 3. During this process, a plurality of rotary rollers 4 smoothly transports the mulch film.

Subsequently, a drip irrigation hose 62 is buried under the mulch film supplied with the seeds through the mulch film laying unit 60 via a plurality of rollers 64, 65, and a fertilizer is supplied to the mulch film through a fertilizer applicator 80 while breaking up the soil through the rotorvator 70.

The present disclosure produces the mulch film based on the plant-derived biodegradable film. The eco-friendly adhesive free of volatile organic compounds (VOC) is preferably supplied to the mulch film.

The cutting and adhesion unit 10 includes a cutting actuator 11, a pivot plate 12 pivotably coupled through the cutting actuator 11, a cutting blade unit 20 coupled to the pivot plate 12, an adhesive supply unit 30 coupled to the cutting blade unit 20 to supply the adhesive, and an adhesion roller unit 40 to transport the adhesive supplied from the adhesive supply unit 30 to the germination gaps formed in the biodegradable film 1.

The cutting actuator 11 has a cylinder 11a and a cylinder rod 11b retractably coupled to the cylinder to make a reciprocating motion on an axis. That is, in response to an operation signal from a control unit, the cylinder rod 11b moves along the outward or inward direction from the cylinder 11a to change the location of the pivot plate 12.

The pivot plate 12 has a triangular shape that is narrower as it goes rearwards from two ends of the plate surface to which the cutting blade unit 20 and the adhesion roller unit 40 are coupled, and the upper end of the cylinder rod 11b is rotatably coupled to the rear tip.

The cutting blade unit 20 has a blade support 21 extended and coupled to the pivot plate 12 at an upper part on one side and a cutting blade 22 disposed along the vertical direction from the outer end of the blade support 21.

The adhesive supply unit 30 includes an adhesive supply body 31 secured to the blade support 21 along the vertical direction, an adhesive supply line 32 disposed below the adhesive supply body 31 and acting as a movement path of the adhesive, and a roller ball 33 attached to the lower end of the adhesive supply line. The roller ball 33 has a function that is similar to a ball at the tip of a ballpoint pen, and allows the supply of the adhesive in the adhesive supply line 32 to the adhesion roller unit 40 through contact with the roller ball 33 during rotation of the adhesion roller unit 40. Through this, the adhesive supplied to the outer circumferential surface of the adhesion roller unit 40 is supplied to the germination gaps in the biodegradable film by the rotation of the adhesion roller unit.

The adhesion roller unit 40 includes a roller support 41 extended and coupled to the pivot plate 12 at a lower part on one side and an adhesion roller 42 rotatably coupled to the roller support 41 and configured to supply the adhesive supplied through the roller ball 33 of the adhesive supply unit to the germination gaps formed in the biodegradable film.

The seed supply unit 50 includes a seed supply hopper 51, a seed supply hose 52 connected to the lower part of the seed supply hopper 51 to transport seeds to the germination gaps formed in the biodegradable film, a seed supply nozzle 53 coupled to the lower end of the seed supply hose 52, a seed collection hose 54 connected to the upper part of the seed supply hopper 51 to collect seeds falling off from the germination gaps formed in the biodegradable film and a seed bowl 55 disposed at the lower end of the seed collection hose 54 to temporarily store the seeds leaking from the germination gaps formed in the biodegradable film.

When some of the seeds supplied to the biodegradable film leak through the seed supply nozzle 53, timely collection of seeds may be achieved through a structure of allowing seeds to fall down to the seed bowl 55 disposed below the seed supply nozzle 53.

The whole process of producing the seedfilm by attaching seeds to the biodegradable film will be described below.

First, upon starting, the cutting and adhesion unit 20 lifted down to the right pivots through the cutting actuator 11 and is located in the vertical direction. While the biodegradable film roll is unwound from the mulch film supply unit 2, the germination gaps are formed using the cutting blade 22 and the eco-friendly adhesive is applied between the germination gaps formed by the cutting blade unit through the adhesive supply unit 30. In this instance, the adhesive is supplied through the tubular roller ball 33 of the ballpoint pen structure. The seeds are transported and supplied by air through the seed supply hose 52 and the seed supply nozzle 53 to minimize damage to the seeds.

The seeds are dropped down and attached to the adhesive application site through the adhesive supply unit 30, and unattached seeds are collected by air suction through the seed bowl and the seed collection hose.

The mulch film laying unit 60 includes a drip irrigation hose supply unit 61, a top alignment roller 63 to perform a pre-alignment operation on the drip irrigation hose 62 unwound from the drip irrigation hose supply unit, the fertilizer applicator 80 to supply a predetermined amount of fertilizer to the drip irrigation hose while rotating, a fertilizer supply conduit 67 connected to the bottom of the fertilizer applicator 80 and accommodating the drip irrigation hose 62, the plurality of rollers 64, 65 for placing the seedfilm on the supplied drip irrigation hose together, and the rotorvator 70 to turn over the soil to make it easy to lift the farmland soil to the seedfilm laid on the farmland.

The plurality of rollers 64, 65 includes a touch roller 64 to guide an initial stack between the drip irrigation hose 62 to which the fertilizer was applied through the fertilizer supply conduit 67 and the supplied seedfilm, and a spreader roller 65 to stably spread the coupled stack of the seedfilm and the drip irrigation hose on the farmland.

A process of laying the biodegradable film having the seeds attached thereto on the farmland using a laying machine dragged by a tractor T will be described below.

First, the drip irrigation hose 62 unwound from the drip irrigation hose supply unit 61 undergoes the pre-alignment operation and the predetermined amount of fertilizer is delivered to the drip irrigation hose 62 through the fertilizer applicator 80.

While the seedfilm is laid on the farmland, the drip irrigation hose is buried under the seedfilm, and in this instance, the drip irrigation hose 62 passes through the top alignment roller 63 and is located under the seedfilm through the underlying touch roller 64.

To lay the seedfilm and the drip irrigation hose together, the seedfilm and the drip irrigation hose pass through the spreader roller 65 at the same time. The fertilizer is applied in bands under the seedfilm.

The seedfilm stacked on the drip irrigation hose is laid on the farmland, and covered with the soil lifted from the farmland through the rotorvator. In this instance, in order to easily lift the farmland soil, a soil tiller plate is placed perpendicular to the rotation direction of the rotorvator to make soil tillage easy.

The seedfilm production apparatus according to the present disclosure produces the seedfilm by supplying seeds to the supplied mulch film that is derived from plants and biodegradable with minimized seed damage using the seed attacher, wherein the mulch film is coated with the eco-friendly adhesive through the cutting and adhesion unit.

The foregoing description is made to describe the technical spirit of the present disclosure for illustrative purposes, and it is obvious to those skilled in the art that a variety of modifications and change may be made thereto without departing from the essential features of the present disclosure. Therefore, the embodiments disclosed herein are provided to describe the technical spirit of the present disclosure and not intended to be limiting, and the technical spirit and scope of the present disclosure is not limited by the embodiments. The scope of protection of the present disclosure should be interpreted by the appended claims, and it should be interpreted that the scope of protection of the present disclosure covers all the technical spirit within the equivalent scope.

1. A seedfilm supply apparatus comprising:
a cutting and adhesion unit configured to form germination gaps for seed attachment in a biodegradable film supplied from a mulch film supply unit;
a seed supply unit configured to feed seeds into the germination gaps formed through the cutting and adhesion unit; and
a mulch film laying unit configured to lay the biodegradable film having the seeds attached thereto on a farmland and cover the biodegradable film with soil by a soil tiller unit,
wherein the cutting and adhesion unit includes a cutting actuator, a pivot plate pivotably coupled through the cutting actuator, a cutting blade unit coupled to the pivot plate, an adhesive supply unit coupled to the cutting blade unit to supply an adhesive, and an adhesion roller configured to transport the adhesive supplied from the adhesive supply unit to the germination gaps formed in the biodegradable film.

2. The seedfilm supply apparatus according to claim 1, wherein the seed supply unit includes a seed supply hopper, a seed supply hose connected to a lower part of the seed supply hopper to transport the seeds to the germination gaps formed in the biodegradable film, a seed supply nozzle coupled to a lower end of the seed supply hose, a seed collection hose connected to an upper part of the seed supply hopper to collect seeds falling off from the germination gaps formed in the biodegradable film and a seed bowl disposed at a lower end of the seed collection hose to temporarily store the seeds leaking from the germination gaps formed in the biodegradable film.

3. The seedfilm supply apparatus according to claim 1, wherein the adhesive supply unit includes an adhesive supply body, an adhesive supply line disposed below the adhesive supply body to act as a movement path of the adhesive, and a roller ball attached to a lower end of the adhesive supply line.

4. The seedfilm supply apparatus according to claim 1, wherein the mulch film laying unit includes a drip irrigation hose supply unit, a fertilizer applicator to supply a predetermined amount of fertilizer to the drip irrigation hose while rotating, a plurality of rollers for placing the seedfilm on the supplied drip irrigation hose together, and a rotorvator to turn over the soil to easily lift the farmland soil to the seedfilm laid on the farmland.
